(19) United States
(12) Patent Application Publication
(10) Pub. No.: US 2026/0244243 A1
(43) Pub. Date: Aug. 20, 2026

(54) Antenna Integrated Display

(71) Applicant: Google LLC, Mountain View, CA (US)

(72) Inventors: Choongho Lee, San Diego, CA (US); Chih-Chun Chang, Hsinchu-City (TW); Sangmoo Choi, Palo Alto, CA (US); Gang Cheng, Burlingame, CA (US)

(21) Appl. No.: 19/159,505

(22) PCT Filed: Mar. 5, 2024
(86) PCT No.: PCT/US2024/018514

§ 371 Date: Aug. 25, 2025

Related U.S. Application Data
(60) Provisional application No. 63/491,162, filed on Mar. 20, 2023.

(51) Int. Cl. G06F 1/16; H01Q 1/22

(52) U.S. Cl. CPC G06F 1/163; G06F 1/1698; H01Q 1/2266

(57) ABSTRACT

A display assembly includes a display cover defining an internal volume having a central portion and a peripheral portion. The display includes a first display area disposed within the central portion of the internal volume and having a first plurality of pixels, a second display area disposed at least partially within the peripheral portion of the internal volume and having a second plurality of pixels, the second display area extending around a periphery of the first display area; and a non-pixelated region disposed within the internal volume between the first and second display areas and around the periphery of the first display area. The display assembly also includes an antenna region having at least one antenna arranged within the non-pixelated region and an opaque coating arranged on an inner surface of the display cover so as to cover the antenna arranged within the non-pixelated region.

### PRIORITY CLAIM

The present application is based on and claims priority to U.S. Provisional Application 63/491,162 having a filing date of Mar. 20, 2023, which is incorporated by reference herein.

### FIELD

The present disclosure relates generally to displays for wearable computing devices. More particularly, the present disclosure relates to a display assembly for wearable computing devices having an integrated antenna.

### BACKGROUND

Wearable computing devices (e.g., wrist watches) can include a display for displaying content (e.g., time, date, applications, etc.) to a user. Wearable computing devices can gather data regarding activities performed by the user, or regarding the user's physiological state. Such data may include data representative of the ambient environment around the user or the user's interaction with the environment. For example, the data can include motion data regarding the user's movements and/or physiological data obtained by measuring various physiological characteristics of the user, such as heart rate, perspiration levels, and the like.

Wearable computing devices generally include electronic components, such as wireless circuitry, a wireless transceiver, and various antennas. Typically, radio frequency (RF) transceivers are coupled to the antennas to support communications with external equipment. Accordingly, the transceiver uses an antenna to transmit and receive wireless signals. However, it can be difficult to effectively incorporate the antennas into the wearable computing devices.

### SUMMARY

Aspects and advantages of embodiments of the present disclosure will be set forth in part in the following description, or can be learned from the description, or can be learned through practice of the embodiments.

In an aspect, the present disclosure is directed to a display assembly having a display cover defining an internal volume having a central portion and a peripheral portion. The display includes a first display area disposed within the central portion of the internal volume and having a first plurality of pixels, a second display area disposed at least partially within the peripheral portion of the internal volume and having a second plurality of pixels, the second display area extending around a periphery of the first display area; and a non-pixelated region disposed within the internal volume between the first and second display areas and around the periphery of the first display area. The display assembly also includes an antenna region having at least one antenna arranged within the non-pixelated region and an opaque coating arranged on an inner surface of the display cover so as to cover the antenna arranged within the non-pixelated region.

In another aspect, the present disclosure is directed to a method of manufacturing a display assembly. The method includes forming a display cover having an internal volume with a central portion and a peripheral portion. The method also includes arranging a display having a first display area, a second display area, and a non-pixelated region within the internal volume, the first display area being disposed within the central portion of the internal volume and having a first plurality of pixels, the second display area being disposed at least partially within the peripheral portion of the internal volume and having a second plurality of pixels, the second display area extending around a periphery of the first display area, the non-pixelated region being disposed within the internal volume between the first and second display areas and around the periphery of the first display area, the non-pixelated region comprising an antenna region with at least one antenna. Moreover, the method includes printing, with an electrically conductive ink, an opaque coating onto an inner surface of the display cover, wherein the opaque coating covers at least a portion of the antenna in the non-pixelated region.

In yet another aspect, the present disclosure is directed to a wearable computing device. The wearable computing device includes a housing and a display cover positioned on the housing. The display cover defines an internal volume having a central portion and a peripheral portion and a display. The display includes a first display area disposed within the central portion of the internal volume and having a first plurality of pixels, a second display area disposed at least partially within the peripheral portion of the internal volume and having a second plurality of pixels, the second display area extending around a periphery of the first display area; and a non-pixelated region disposed within the internal volume between the first and second display areas and around the periphery of the first display area. The display assembly also includes an antenna region having at least one antenna arranged within the non-pixelated region and an opaque coating arranged on an inner surface of the display cover so as to cover the antenna arranged within the non-pixelated region.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 illustrates an embodiment of a wearable computing device according to example embodiments of the present disclosure;

FIG. 2 illustrates a cross-sectional view of an example wearable computing device according to example embodiments of the present disclosure;

FIG. 3 illustrates an exploded view of a wearable computing device according to example embodiments of the present disclosure;

FIG. 4 illustrates a perspective view of an example display cover for a wearable computing device according to example embodiments of the present disclosure;

FIG. 5 illustrates a bottom view of the example display cover of FIG. 4 according to example embodiments of the present disclosure;

FIG. 6 illustrates a perspective view of an example display assembly according to example embodiments of the present disclosure;

FIG. 7 illustrates a block diagram of components of an example display assembly according to example embodiments of the present disclosure;

FIG. 8 illustrates a cross-sectional view of the example display assembly of FIG. 6 according to example embodiments of the present disclosure;

FIG. 9 illustrates a block diagram of components of an example display assembly according to example embodiments of the present disclosure;

FIG. 10 illustrates a flow diagram of a method of manufacturing a display assembly of a wearable computing device according to example embodiments of the present disclosure; and

FIG. 11 illustrates a block diagram of components of a computing system of an example wearable computing device according to example embodiments of the present disclosure.

### DETAILED DESCRIPTION

Reference now will be made in detail to embodiments of the present disclosure, one or more examples of which are illustrated in the drawings. Each example is provided by way of explanation of the present disclosure, not limitation of the present disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure are directed to a wearable computing device that can be worn, for instance, on a user's wrist. The wearable computing device can include a housing and a display. The display can be configured to display content for viewing by the user. The wearable computing device can further include a display cover positioned on the housing such that the display cover is positioned over the display. In this manner, the display cover can protect the display from being damaged (e.g., scratched). Furthermore, the display cover can include a transparent material (e.g., glass). In this manner, the user can view the content on the display assembly through the display cover.

Example aspects of the present disclosure are directed to a display assembly that can be used in wearable computing devices. The display assembly includes a display cover which defines an internal volume. The display assembly further includes a display (e.g., organic light emitting diode (OLED) display) positioned within the internal volume. It should be understood that the display cover can be positioned above the display disposed within the internal volume. Furthermore, the display includes a first display area (e.g., primary display area), a second display area, and a non-pixelated region between the first and second display areas. It should be understood that the first display area and the second display area can each include a plurality of pixels. The first display area is disposed within a central portion of the internal volume. The second display area is disposed at least partially within a peripheral portion of the internal volume. For instance, the second display area can extend around a periphery of the first display area within the internal volume. The display further includes an antenna arranged on an inner surface of the display cover, wherein the antenna covers at least a portion of the non-pixelated region Thus, the antenna makes useful the otherwise unused space created by the non-pixelated region. The proposed solution thus allows for a compact design for a display assembly including an antenna.

In an embodiment, at least a portion of the antenna is curved. For example, in an embodiment, the display cover may include a first portion and a second portion, with the first portion being substantially flat and the second portion having a curved shape. Thus, by arranging the antenna on the inner surface of the display cover, at least a portion of the antenna is also curved as the antenna follows a shape of the display cover. Furthermore, in an embodiment, the antenna may extend along and cover an entirety of the second portion of the display cover. The second portion can have an annular and/or arcuate shape. Furthermore, the second portion of the three-dimensional display cover can (circumferentially) extend around a periphery of the first portion of the three-dimensional display cover.

In an embodiment, the antenna may be printed on the inner surface of the display cover. For example, in an embodiment, the antenna may be formed or otherwise constructed of an electrically conductive ink printed to the inner surface of the display cover. For example, in an embodiment, the electrically conductive ink may be a metal-based ink or a polymer-based ink. Further, in an embodiment, the electrically conductive ink is opaque. As such, the opaque electrically conductive ink is configured to cover a portion of the display cover, which is typically formed from a transparent material, so as to hide certain internal components within the internal volume of the display cover. Thus, the antenna makes useful the otherwise unused space created by the non-pixelated region.

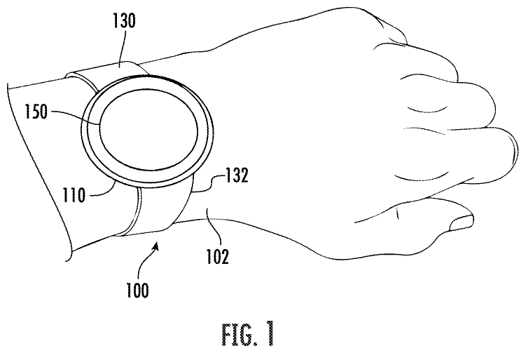

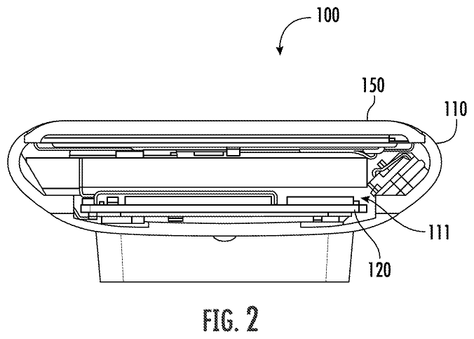

Referring now to the figures, FIGS. 1 through 3 depict a wearable computing device 100 according to some implementations of the present disclosure. As shown, the wearable computing device 100 can be worn, for instance, on an arm 102 (e.g., wrist) of a user. For instance, the wearable computing device 100 can include a housing 110. The housing 110 can define a cavity 111 (FIG. 2) in which one or more electronic components (e.g., disposed on printed circuit boards) are disposed. For instance, as shown in FIG. 2, the wearable computing device 100 can include a printed circuit board 120 disposed within the cavity 111. Furthermore, one or more electronic components can be disposed on the printed circuit board 120. The wearable computing device 100 can further include a battery (not shown) that is disposed within the cavity 111 defined by the housing 110.

The wearable computing device 100 can include a first band 130 and a second band 132. As shown, the first band 130 can be coupled to the housing 110 at a first location thereon. Conversely, the second band 132 can be coupled to the housing 110 at a second location thereon. Furthermore, the first band 130 and the second band 132 can be coupled to one another to secure the housing 110 to the arm 102 of the user.

In some implementations, the first band 130 can include a buckle or clasp (not shown). Additionally, the second band 132 can include a plurality of apertures (not shown) spaced apart from one another along a length of the second band 132. In such implementations, a prong of the buckle associated with the first band 130 can extend through one of the plurality of openings defined by the second band 132 to couple the first band 130 to the second band 132.

It should be appreciated that the first band 130 can be coupled to the second band 132 using any suitable type of fastener. For instance, in some implementations, the first band 130 and the second band 132 can include a magnet. In such implementations, the first band 130 and the second band 132 can be magnetically coupled to one another to secure the housing 110 to the arm 102 of the user.

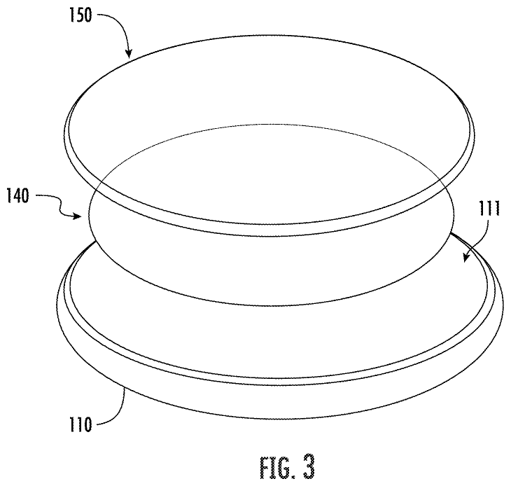

Referring particularly to FIG. 3, the wearable computing device 100 can include a display 140 configured to display content (e.g., time, date, biometric, notifications, etc.) for viewing by the user. For instance, the display 140 can include a plurality of pixels. In some implementations, the display 140 can include an organic light emitting diode (OLED) display. It should be understood, however, that the display 140 can include any suitable type of display.

The wearable computing device 100 can include a display cover 150 positioned on the housing 110 so that the display cover 150 is positioned on top of the display 140. In this manner, the display cover 150 can protect the display 140 from being scratched or damaged. In some implementations, the wearable computing device 100 can include a seal (not shown) positioned between the housing 110 and the display cover 150. For instance, a first surface of the seal can contact the housing 110 and a second surface of the seal can contact the display cover 150. In this manner, the seal between the housing 110 and the display cover 150 can prevent a liquid (e.g., water) from entering the cavity 111 defined by the housing 110.

It should be understood that the display cover 150 can be optically transparent so that the user can view information being displayed on the display 140. For instance, in some implementations, the display cover 150 can include a glass material. It should be understood, however, that the display cover 150 can include any suitable optically transparent material.

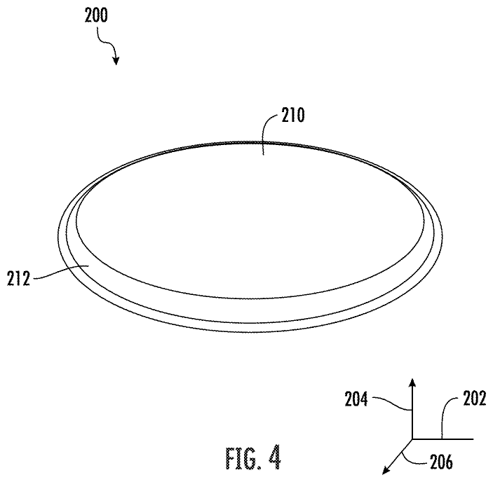

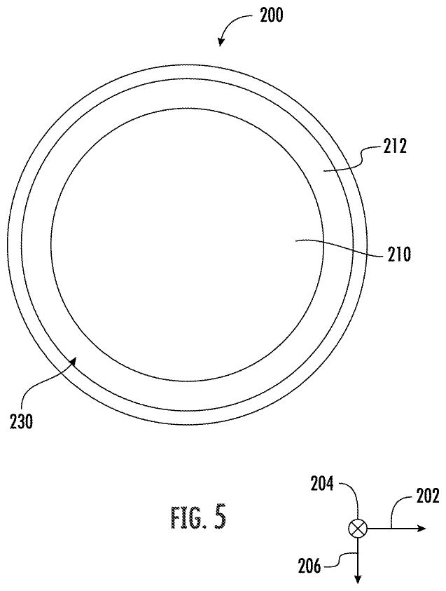

Referring now to FIGS. 4 and 5, a three-dimensional display cover 200 for a wearable computing device is provided. The three-dimensional display cover 200 defines an x-axis 202, a y-axis and a z-axis 206. It should be understood that the x-axis 202, the y-axis 204, and the z-axis 206 are substantially perpendicular (e.g., less than a 15-degree difference, less than a 10-degree difference, less than a 5-degree difference, less than a 1-degree difference, etc.) to one another. It should also be understood that wearable computing device 100 discussed above with reference to FIGS. 1 through 3 can include the three-dimensional display cover 200. For instance, the display cover 150 discussed above with reference to FIGS. 1 through 3 can include the three-dimensional display cover 200. Details of the three-dimensional display cover 200 will now be discussed.

The three-dimensional display cover 200 can include a first portion 210 and a second portion 212. The first portion 210 of the three-dimensional display cover 200 can extend along the x-axis 202 and the z-axis 206. In this manner, the first portion 210 can be substantially flat. The second portion 212 of the three-dimensional display cover 200 can extend from the first portion 210 of the three-dimensional display cover 200 along the y-axis 204. The second portion 212 can have an annular and/or arcuate shape. Furthermore, the second portion 212 of the three-dimensional display cover 200 can extend around a periphery of the first portion 210 of the three-dimensional display cover 200. In this manner, the first portion 210 of the three-dimensional display cover 200 and the second portion 212 of the three-dimensional display cover 200 can collectively define an internal volume 230 in which a display of a wearable computing device can be positioned. In some implementations, the three-dimensional display cover 200 can have a frustoconical shape.

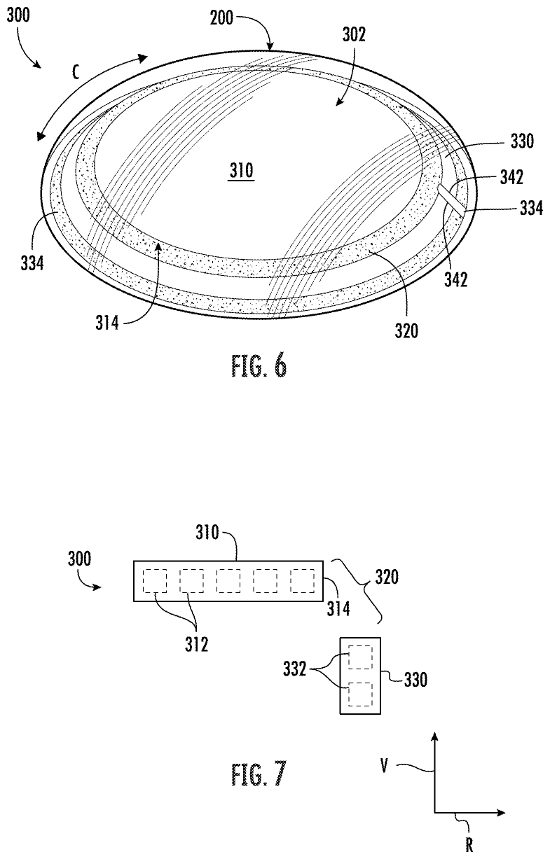

Referring now to FIGS. 6 and 7, a display assembly 300 for a wearable computing device is provided according to some implementations of the present disclosure. In some implementations, the display assembly 300 can define a circumferential direction C, a radial direction R, and a vertical direction V. The display assembly 300 can be implemented in wearable computing devices that include a three-dimensional cover. For example, the display assembly 300 can be used in a wearable computing device that includes the three-dimensional display cover 200 depicted in FIGS. 4 and 5.

As shown, the display assembly 300 includes a display 302 having a first display area 310 (e.g., main display) with a first plurality of pixels 312. In an embodiment, the first display area 310 faces the (central) first portion of the three-dimensional display cover 200 when the display assembly 300 and the three-dimensional display cover 200 are assembled. For instance, the first plurality of pixels 312 can include a total number of pixels needed to cover a substantial portion (e.g., greater than 90 percent) of the first display area 310. The first display area 310 can display content for viewing by a user of the wearable computing device. Furthermore, the first display area 310 can have a substantially circular shape. In some implementations, the first display area 310 can be substantially flat.

The display 302 includes a second display area 330 (e.g., sub-display) having a second plurality of pixels 332. In this manner, the second display area 330 can display content for viewing by the user of the wearable computing device. In the illustrated embodiment, the second display area 330 is smaller than the first display area 310. For example, the first display area 310 has a size which is a multiple-not necessarily an integer multiple-of a size of the second display area 330. In some implementations, the second plurality of pixels 332 can include a total number of pixels needed to cover a substantial portion (e.g., greater than 90 percent) of the second display area 330. As shown in FIG. 7, the second plurality of pixels 332 can, in some implementations, be arranged in a plurality of rows. Furthermore, the pixels included in each of the plurality of rows can be spaced apart from one another along the circumferential direction C. In this manner, the second display area 330 can display content for viewing by the user of the wearable computing device through the second portion 212 of the three-dimensional display cover 200.

In some implementations, the second display area 330 can have a substantially annular shape (e.g., ring shape) that generally extends around the first display area 310. Additionally, as shown in FIG. 6, a gap 334 may be defined between (circumferential) ends 342 of the second display area 330. For example, the gap 334 can be defined along the circumferential direction C between the ends 342 of the second display area 330—the ends 342 facing each other. In alternative implementations, the ends 342 of the second display area 330 can contact (e.g., touch) each other such that there is no gap defined therebetween.

In some implementations, the second display area 330 can be configured as an always-on display. Alternatively, or additionally, the second display area 330 can be configured as a touch-screen display. For instance, the second display area 330 can include one or more touch sensors. In this manner, the user can provide user-input (e.g., touch, scroll, etc.) via the second display area 330.

The display assembly 300 can also include a non-pixelated region, which in some instances, may be used as an antenna region 320. Thus, in an embodiment, the non-pixelated region, as an example, may generally refer to an area that is void of any pixels or touch sensor(s). In this manner, the non-pixelated region does not display content to the user and does not have touch interaction with the user. Rather, the non-pixelated region, when used as the antenna region 320, may instead include one or more hardware components of the display assembly 300, such as printed circuit boards, wiring, etc. that do not need to be viewed by the user. As shown, the non-pixelated region used as the antenna region 320 is generally between the first display area 310 and the second display area 330. For instance, the non-pixelated region used as the antenna region 320 can extend outwardly from a periphery 314 of the first display area 310 along the radial direction R. For example, the non-pixelated region used as the antenna region 320 can extend from the periphery 314 of the first display area 310 along the radial direction R and the vertical direction V. Furthermore, in some implementations, the non-pixelated region used as the antenna region 320 can be curved. For example, the non-pixelated region used as the antenna region 320 can extend from the periphery 314 of the first display area 310 along the radial direction R and the vertical direction V.

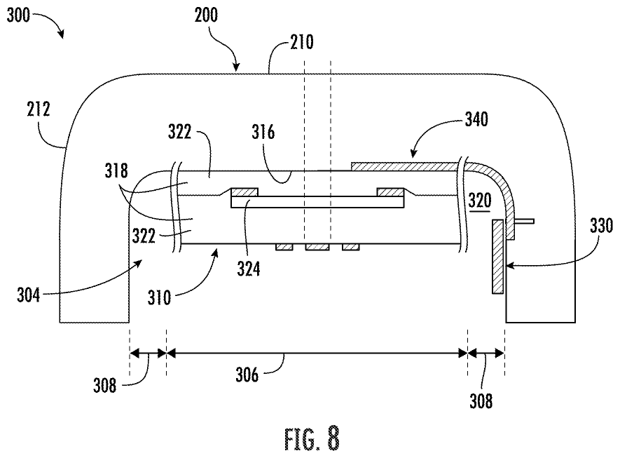

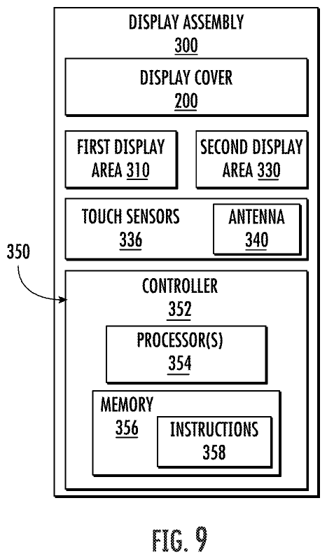

Referring particularly to FIG. 8, a cross-sectional view of the example display assembly 300 of FIG. 6 is provided according to example embodiments of the present disclosure. The display assembly 300 can be implemented in wearable computing devices such as, for instance, the wearable computing device 100 discussed above with reference to FIG. 1 through FIG. 3. It should be understood, however, that the display assembly 300 can be used in any suitable electronic device. Furthermore, the display assembly 300 can include a display cover 302. For instance, in some embodiments, the display assembly 300 can include the display cover 200 discussed above with reference to FIG. 4 and FIG. 5. It should be understood, however, that the display assembly 300 can include any suitable display cover for a display of an electronic device.

More specifically, as shown and as mentioned, the display assembly 300 includes the three-dimensional display cover 200 defining an internal volume 304 and the display 302 at least partially or completely disposed within the internal volume 304. The display 302 can include the first display area 310 and the second display area 330 discussed above with reference to FIGS. 6 and 7. As shown, the first display area 310 and the second display area 330 can be at least partially positioned within the internal volume 304 defined by the display cover 200. In this manner, the display cover 200 can protect the first display area 310 and the second display area 330 from being damaged (e.g., scratched, cracked). Moreover, as shown in FIG. 8, the first display area 310 can include a plurality of different layers 318. It should be understood that the plurality of different layers 318 can be stacked on top of one another to form the first display area 310. It should also be understood that the layers 318 can include different materials and/or components. For instance, a display layer of the first display area 310 can include a plurality of pixels that can be controlled to display content for viewing by a user. Furthermore, in some embodiments, the first display area 310 can include a plurality of different display areas, such as one or more optical clear adhesive (OCA) layers 322, an additional antenna 324, and/or one or more layers of polyimide (PI). In such embodiments, as an example, the additional antenna 324 may be formed of a plastic material.

In further embodiments, as shown, the internal volume 304 can include a central portion 306 and a peripheral portion 308 extending around a periphery of the central portion 306 in a circumferential direction. Accordingly, as shown, in some embodiments, the non-pixelated region is used as the antenna region 320 and may be generally located within the peripheral portion 308 of the internal volume 304 between the first and second display areas 310, 330.

Moreover, as shown in FIG. 8, the display assembly 300 includes the antenna region 320 and an opaque coating 340 arranged on an inner surface 316 of the display cover 200 facing at least a portion of the internal volume 304. In an embodiment, the opaque coating 340 described herein generally refers to a metallic structure that serves as a specialized transducer to capture and/or transmit radio electromagnetic waves to alternating current or vice-versa. As shown, the opaque coating 340 (when viewed from the outside) covers at least a portion of the non-pixelated region used as the antenna region 320. In an embodiment, as shown in FIG. 8, at least a portion of the antenna region 320 with the opaque coating 340 is curved. For example, as shown and mentioned, the three-dimensional display cover 200 includes the first portion 210 and the second portion 212, with the first portion 210 being substantially flat and the second portion 212 having a curved shape. Thus, by arranging the antenna region 320 adjacent to the opaque coating 340, at least a portion of the opaque coating 340 is also curved as the antenna region 320 follows a shape of the display cover 200. Furthermore, in an embodiment, the opaque coating 340 may extend along and cover an entirety of the second portion 212 of the display cover 200. In alternative embodiments, the opaque coating 340 may extend along and cover only part of the second portion 212 of the display cover 200.

In particular embodiments, the opaque coating 340 may be printed on the inner surface 316 of the display cover 200 facing at least a portion of the internal volume 304 (such as on inner surface 316). For example, in an embodiment, the opaque coating 340 may be formed or otherwise constructed of an electrically conductive ink printed to the inner surface 316 of the display cover 200. Any suitable printing techniques can be utilized to print the opaque coating 340 on the inner surface 316 of the display cover 200, such as surface printing, flexographic printing, screen printing, gravure printing, digital printing, additive manufacturing, etc.

In further embodiments, the electrically conductive ink may be a metal-based ink. Alternatively, the electrically conductive ink may be a polymer-based ink. Thus, in particular embodiments, the electrically conductive ink is opaque. As such, the opaque electrically conductive ink is configured to cover a portion of the display cover 200, which is typically formed from a transparent material, so as to hide certain internal components within the internal volume 304 of the display cover 200.

Referring now to FIG. 9, a block diagram of components of an example display assembly 300 for use with a display cover is provided according to example embodiments of the present disclosure. For instance, in some embodiments, the display assembly 300 can include the display cover 200 discussed above with reference to FIGS. 4-8. It should be understood, however, that the display assembly 300 can include any suitable display cover for a display of an electronic device.

The display assembly 300 can include a plurality of touch sensors 336 for detecting touch input by the user touching the display cover 200 (FIG. 4 and FIG. 5). For instance, the plurality of touch sensors 336 can include a first plurality of touch sensors operable to detect a touch input provided by the user touching the central portion 210 (FIGS. 4 and 5) of the display cover 200 and a second plurality of touch sensors operate to detect a touch input provided by the user touching the peripheral portion 212 (FIGS. 4 and 5) of the display cover 200.

In some embodiments, one or more of the touch sensors 336 can include a capacitive sensor whose capacitance changes when touch input is provided at a location on the display cover 200 that corresponds to the capacitive sensor. It should be understood, however, that the touch sensors 336 can include any suitable type of sensor configured to detect touch input provided by the user touching the display cover 200.

The display assembly 300 can include a display driver circuit 350 having a controller 352. The controller 352 can include one or more processors 354 and a memory 356. The processor(s) 354 can be communicatively coupled to the antenna region 320 and the plurality of touch sensors 336. In this manner, the processor(s) 354 can receive signals from the antenna region 320 with the opaque coating 340 and/or the plurality of touch sensors 336. Furthermore, the memory 356 can store instructions 358 that, when executed by the processor(s) 354, cause the processor(s) 354 to process the signals received from the antenna region 320 with the opaque coating 340 and/or the plurality of touch sensors 336 and perform one or more actions based on the location at which the input was provided. For instance, in some embodiments, the processor(s) 354 can be configured to update the content displayed by the display 302, specifically the display layer thereof.

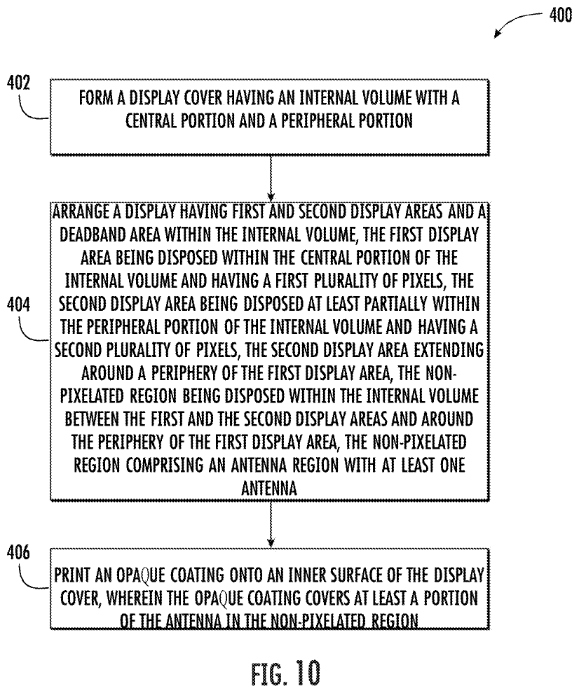

Referring now to FIG. 10, a flow diagram of an embodiment of a method 400 of manufacturing a display assembly is illustrated. The method 400 of FIG. 10 may be utilized to form a display assembly, such as display assembly 300, described herein with reference to FIGS. 1 through 9. However, in other exemplary aspects, the method 400 may additionally or alternatively be utilized to manufacture any other suitable display assembly. In addition, although FIG. 10 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown at (402), the method 400 includes forming a display cover having an internal volume with a central portion and a peripheral portion. As shown at (404), the method 400 includes arranging a display having a first display area, a second display area, and a non-pixelated region within the internal volume, the first display area being disposed within the central portion of the internal volume and having a first plurality of pixels, the second display area being disposed at least partially within the peripheral portion of the internal volume and having a second plurality of pixels, the second display area extending around a periphery of the first display area, the non-pixelated region being disposed within the internal volume between the first and second display areas and around the periphery of the first display area, the non-pixelated region comprising an antenna region with at least one antenna. As shown at (406), the method 400 includes arranging (e.g., depositing), in particular printing, with an electrically conductive ink, an opaque coating on an inner surface of the display cover such that the opaque coating covers at least a portion of the antenna of the non-pixelated region.

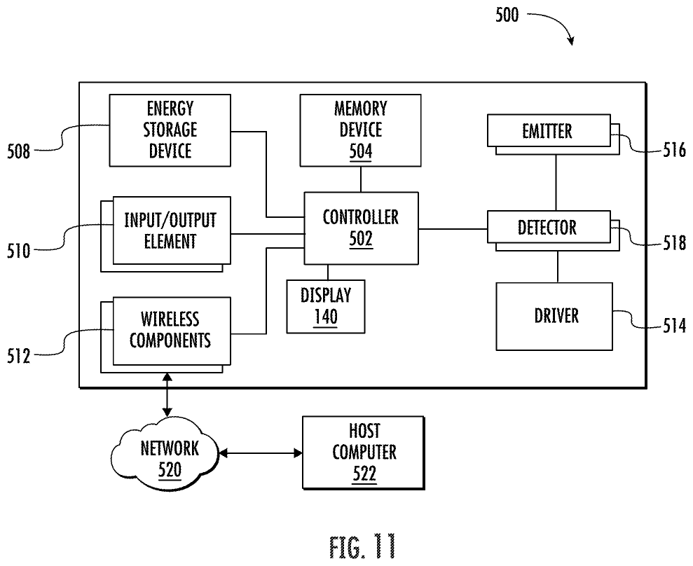

Referring now to FIG. 11, components of an example computing system 500 of the wearable computing device 100 that can be utilized in accordance with various embodiments are illustrated. In particular, as shown, the computing system 500 may include at least one controller 502. Moreover, in some embodiments, the controller(s) 502 can be a central processing unit (CPU) or graphics processing unit (GPU) for executing instructions that can be stored in a memory device 504, such as flash memory or DRAM, among other such options. For instance, in some embodiments, the memory device 504 may include RAM, ROM, FLASH memory, or other non-transitory digital data storage, and may include a control program comprising sequences of instructions which, when loaded from the memory device 504 and executing using the controller(s) 502, cause the controller(s) 502 to perform the functions that are described herein.

The computing system 500 can include many types of memory, data storage, or computer-readable media, such as data storage for program instructions for execution by the controller(s) 502 or any suitable processor. The same or separate storage can be used for images or data, a removable memory can be available for sharing information with other devices, and any number of communication approaches can be available for sharing with other devices. In addition, as shown, the computing system 500 includes the display 140, which may be a touch screen, organic light-emitting diode (OLED), or liquid crystal display (LCD), although devices might convey information via other means, such as through audio speakers, projectors, or casting the display or streaming data to another device, such as a mobile phone, wherein an application on the mobile phone displays the data.

The computing system 500 can include one or more wireless networking components 512 operable to communicate with one or more electronic devices within a communication range of a particular wireless channel. The wireless channel can be any appropriate channel used to enable devices to communicate wirelessly, such as Bluetooth, cellular (e.g., 3G, 4G, LTE, 5G), near-field communication (NFC), Ultra-Wideband (UWB), or Wi-Fi channels. It should be understood that the computing system 500 can have one or more conventional wired communications connections as known in the art.

The computing system 500 can also include one or more power components 508 (e.g., energy storage device(s)) operable to be recharged through conventional plug-in approaches. In some embodiments, the computing system 500 can also include at least one additional Input/Output (I/O) device 510 operable to receive conventional inputs from a user. These conventional inputs can include, for instance, a push button, touch pad, touch screen, wheel, joystick, keyboard, mouse, keypad, or any other suitable device or element whereby a user can input a command to the computing system 500. In some embodiments, the I/O device(s) 510 can be connected by a wireless infrared or Bluetooth or other link as well. In some embodiments, the computing system 500 can include a microphone or other audio-capture element that accepts voice or other audio commands. In some embodiments, the I/O device(s) 510 can include one or more electrodes, optical sensors, barometric sensors (e.g., altimeter, etc.), and the like.

The computing system 500 can include a driver 514 and at least some combination of one or more emitters 516 and one or more detectors 518 for measuring data for one or more metrics of a human body, such as for a person wearing the wearable computing device 100. In some embodiments, for instance, this may involve at least one imaging element (not shown), such as one or more cameras that are able to capture images of the surrounding environment and that are able to image a user, people, or objects in the vicinity of the device. The image capture element can include any appropriate technology, such as a Charge-Coupled Device (CCD) image capture element having a sufficient resolution, focal range, and viewable area to capture an image of the user when the user is operating the device. Further image capture elements may also include depth sensors. Methods for capturing images using a camera element with a computing device are well known in the art and will not be discussed herein in detail. It should be understood that image capture can be performed using a simple image, multiple images, periodic imaging, continuous image capture, image streaming, etc. Furthermore, the computing system 500 can include the ability to start and/or stop image capture, such as when receiving a command from a user, application, or other device.

The emitters 516 and the detectors 518 may also be capable of being used, in some embodiments, for obtaining optical photoplethysmogram (PPG) measurements. Some PPG technologies rely on detecting light at a single spatial location, or adding signals taken from two or more spatial locations. Both of these approaches result in a single spatial measurement from which the heart rate (HR) estimate (or other physiological metrics) can be determined. In some embodiments, a PPG device employs a single light source coupled to a single detector (e.g., a single light path). Alternatively, a PPG device may employ multiple light sources coupled to a single detector or multiple detectors (e.g., two or more light paths). In other embodiments, a PPG device employs multiple detectors coupled to a single light source or multiple light sources (e.g., two or more light paths). In some instances, the light source(s) may be configured to emit one or more of green, red, infrared (IR) light, as well as any other suitable wavelengths in the spectrum (e.g., long IR for metabolic monitoring). For instance, a PPG device may employ a single light source and two or more light detectors, each of which is configured to detect a different wavelength or wavelength range. In other embodiments, two or more detectors can be configured to detect the same wavelength or wavelength range. In yet another embodiment, one or more detectors can be configured to detect a specific wavelength or wavelength range that is different from one or more other detectors. In embodiments employing multiple paths, the PPG device may determine an average of the signals resulting from the multiple paths before determining an HR estimate or other physiological metrics.

Moreover, in some embodiments, the emitters 516 and the detectors 518 can be coupled to the controller 502 directly or indirectly using driver circuitry by which the controller 502 may drive the emitters 516 and obtain signals from the detectors 518. The host computer 522 can communicate with the wireless networking components 512 via the one or more networks 520, which may include one or more local area networks, wide area networks, UWB, and/or internetworks using any of terrestrial or satellite links. In some embodiments, the host computer 522 can execute control programs and/or application programs that are configured to perform the functions described herein.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A display assembly, comprising:
a display cover defining an internal volume having a central portion and a peripheral portion; and
a display comprising:
a first display area disposed within the central portion of the internal volume and having a first plurality of pixels;
a second display area disposed at least partially within the peripheral portion of the internal volume and having a second plurality of pixels, the second display area extending around a periphery of the first display area; and
a non-pixelated region disposed within the internal volume between the first and second display areas and around the periphery of the first display area;
an antenna region comprising at least one antenna arranged within the non-pixelated region; and
an opaque coating arranged on an inner surface of the display cover so as to cover the antenna arranged within the non-pixelated region.

2. The display assembly of claim 1, wherein at least a portion of the opaque coating is curved.

3. The display assembly of claim 1, wherein the opaque coating is printed on the inner surface of the display cover.

4. The display assembly of claim 1, wherein the display cover comprises a first portion and a second portion, wherein the first portion is substantially flat and the second portion is at least partially curved, and wherein the opaque coating extends along and covers an entirety of the second portion of the display cover.

5. The display assembly of claim 1, wherein the opaque coating is constructed of an electrically conductive ink.

6. The display assembly of claim 5, wherein the electrically conductive ink is metal based.

7. The display assembly of claim 5, wherein the electrically conductive ink is polymer based.

8. The display assembly of claim 5, wherein the display cover is formed from a transparent material and the electrically conductive ink is opaque.

9. The display assembly of claim 1, wherein the display assembly is part of a wearable computing device.

10. The display assembly of claim 1, further comprising a display driver circuit electrically coupled to the antenna.

11. The display assembly of claim 1, wherein the display comprises an organic light-emitting diode (OLED) display.

12. A method of manufacturing a display assembly, the method comprising:
forming a display cover having an internal volume with a central portion and a peripheral portion;
arranging a display having a first display area, a second display area, and a non-pixelated region within the internal volume, the first display area being disposed within the central portion of the internal volume and having a first plurality of pixels, the second display area being disposed at least partially within the peripheral portion of the internal volume and having a second plurality of pixels, the second display area extending around a periphery of the first display area, the non-pixelated region being disposed within the internal volume between the first and second display areas and around the periphery of the first display area, the non-pixelated region comprising an antenna region with at least one antenna; and
printing, with an electrically conductive ink, an opaque coating onto an inner surface of the display cover, wherein the opaque coating covers at least a portion of the antenna in the non-pixelated region.

13. A wearable computing device, comprising:
a housing;
a display cover positioned on the housing, the display cover defining an internal volume having a central portion and a peripheral portion; and
a display comprising:
a first display area disposed within the central portion of the internal volume and having a first plurality of pixels;
a second display area disposed at least partially within the peripheral portion of the internal volume and having a second plurality of pixels, the second display area extending around a periphery of the first display area; and
a non-pixelated region disposed within the internal volume between the first and second display areas and around the periphery of the first display area;
an antenna region comprising at least one antenna arranged within the non-pixelated region; and
an opaque coating arranged on an inner surface of the display cover so as to cover the antenna arranged within the non-pixelated region.

14. The wearable computing device of claim 13, wherein at least a portion of the opaque coating is curved.

15. The wearable computing device of claim 13, wherein the opaque coating is printed on the inner surface of the display cover.

16. The wearable computing device of claim 13, wherein the display cover comprises a first portion and a second portion, wherein the first portion is substantially flat and the second portion is at least partially curved, and wherein the opaque coating extends along and covers an entirety of the second portion of the display cover.

17. The wearable computing device of claim 13, wherein the opaque coating is constructed of an electrically conductive ink.

18. The wearable computing device of claim 17, wherein the electrically conductive ink is metal based.

19. The wearable computing device of claim 17, wherein the electrically conductive ink is polymer based.

20. The wearable computing device of claim 17, wherein the display cover is formed from a transparent material and the electrically conductive ink is opaque.
